(19) United States
(12) Patent Application Publication
(10) Pub. No.: US 2022/0364861 A1
(43) Pub. Date: Nov. 17, 2022

(54) DEVICE FOR MARKING A SURVEY OBJECT

(71) Applicant: Georg Rothbucher, Bad Reichenhall (DE)

(72) Inventor: Georg Rothbucher, Bad Reichenhall (DE)

(21) Appl. No.: 17/745,917

(22) Filed: May 17, 2022

(30) Foreign Application Priority Data
May 17, 2021 (DE) 20 2021 102 669.3

(51) Int. Cl. G01C 15/06

(52) U.S. Cl. CPC G01C 15/06

(57) ABSTRACT

Described is a device for marking a survey object. The device comprises a base having a bottom plate attachable to the survey object, and a rotary plate disposed on the bottom plate and rotatable relative thereto about a first axis, a single support arm projecting from and rotationally fixed relative to the rotary plate, and a survey marker releasably attached to and rotatable relative to the free end of the support arm about a second axis that is perpendicular to the first axis.

### CROSS-REFERENCE TO RELATED APPLICATIONS

This application claims priority to Germany application DE 20 2021 102 669.3, filed May 17, 2021.

### TECHNICAL FIELD

The present invention relates to a device for marking a survey object. Further, the invention relates to a marking apparatus comprising such a device and a surveying tripod and/or a prism pole.

Survey markers are usually attached to stationary objects such as buildings or, in the area of railroad tracks, to electric poles. They serve as fixed points which are measured using known measuring devices such as lasers, scanners and total stations. Accordingly, various types of markers such as target markers and shields specially designed for laser scanners or drones, foldable markers, adhesive markers, ground markers, etc. can be considered as survey markers. There is also a variety of accessories such as adapters that can be used together with such a survey marker.

The variety of different surveying methods requires that a wide range of markers and accessories must be kept available if a large number of possible applications is to be covered. It would therefore be desirable to create a possibility to provide a variety of application possibilities with less effort than before.

### BRIEF DESCRIPTION

It is the object of the invention to specify a device for marking a survey object, which makes it possible to cover a wide range of surveying applications with the aid of a survey marker.

The invention solves this object by a device comprising a base having a bottom plate attachable to the survey object and a rotary plate disposed on the bottom plate and rotatable relative thereto about a first axis. The device includes a single support arm extending from and rotationally fixed relative to the rotary plate. Further, the device includes a survey marker removably attached to the free end of the support arm and rotatable relative thereto about a second axis that is perpendicular to the first axis.

The device according to the invention allows a user to rotate the survey marker about two axes that are perpendicular to each other. This allows the survey marker to be oriented in space as desired. In particular, the spatial orientation of the survey marker can be adapted in a flexible manner to the specific surveying situation, for example, depending on the measuring method used, the type of object to be surveyed, and/or the type of measuring device used. On the one hand, the positioning of the survey marker is carried out by rotating the bottom plate present in the base, via which the base is attached to the survey object, together with the support arm about the first axis. On the other hand, the survey marker itself, which is hinged to the support arm, is rotated about the second axis relative to the support arm. Since there is only one support arm, the invention provides an advantageous space-saving solution, which incidentally also has an attractive design.

For example, the first axis is perpendicular to a plane defined by the bottom plate or the rotary plate of the base. In this case, the second axis runs parallel to the plate plane. If one assumes, for example, that the base is mounted on a horizontal surface, the first axis is oriented in the vertical direction and the second axis is oriented in the horizontal direction.

With the bottom plate and the rotary plate placed thereon, the base of the device according to the invention is substantially made in two parts. The two afore-mentioned plates form, for example, a lower and an upper shell element, respectively, of which the base is composed. This favors a particularly compact structure.

The bottom plate, the rotary plate and the support arm can be components manufactured by an injection molding process, for example. In this case, the rotary plate and the support arm are preferably made in one piece. The use of such injection-molded components is particularly advantageous if the device according to the invention is to be manufactured in large numbers. Alternatively, it is also conceivable to manufacture said components from metal.

In the present context, when the free end of the support arm is referred to, it means the end facing away from the bottom plate to which the support arm is attached.

Preferably, the device comprises a first pivot joint arranged in the base, by means of which the rotary plate is connected to the bottom plate so as to be rotatable about the first axis. This first pivot joint can be formed by interlocking plate parts, which are present on the one hand on the bottom plate and on the other hand on the rotary plate. In this case, said plate parts are preferably made in one piece with the bottom plate and the rotary plate, respectively.

In an advantageous embodiment, the first pivot joint comprises at least one circumferential groove and at least one projection guided in the groove. If the bottom plate and the rotary plate are designed, for example, as shell parts which are placed on top of each other to form the base, the groove and the corresponding projection can be provided at mutually facing edge regions of the two plates. When the plates are put together, the groove and the projection engage with each other such that they can be twisted against each other. In this case, the circumferential groove is located on the rotary plate, for example, while the circumferential projection is formed on the bottom plate (or vice versa). It is also possible to provide a groove and a projection on both the bottom plate and the rotary plate. In this case, the projection of the bottom plate engages in the groove of the rotary plate assigned to it, and the projection of the rotary plate engages in the groove of the bottom plate assigned to it. Thus, an encompassing rotary guide of the undercut type is formed, which enables the desired rotation of the rotary plate relative to the bottom plate.

In addition to the groove guide described above, the first pivot joint can have further joint elements that can be rotated against each other. While the groove and the corresponding projection are preferably located in the edge areas of the bottom plate or the rotary plate, these additional joint elements can be arranged radially inside the edge areas of the plates.

In a particularly preferred embodiment, the first pivot joint includes a first detent mechanism that defines a plurality of rotational detent positions of the rotary plate about the first axis. For example, a plurality of discrete rotational detent positions of the rotary plate relative to the bottom plate may be provided at predetermined angular intervals, (e.g., 60°). For example, the first detent mechanism may include a circumferential wall disposed within the shell opening of one of the two shell-shaped plates and having a plurality of vertically extending detent notches. In this case, the other plate has a plurality of vertically oriented detent lugs corresponding in number, orientation and shape to the detent notches. When the rotary plate is rotated relative to the bottom plate, the detent lugs of one plate slide along the circumferential wall of the other plate and engage in the wall as soon as they enter the detent notches formed in the wall. This not only realizes an advantageous spring detent. Rather, in this case the detent mechanism also forms part of the pivot joint and helps to ensure that the pivot joint is both stable and smooth-running.

In a preferred embodiment, the device comprises a second pivot joint arranged at the free end of the support arm, by means of which the survey marker is connected to the support arm so as to be rotatable about the second axis of rotation. Thus, the second pivot joint is located at the end of the support arm facing away from the bottom plate of the base.

In a particularly preferred embodiment, the second pivot joint comprises an exchange mechanism that enables the survey marker to be detached from and attached to the support arm. Depending on the application, a suitable survey marker can thus optionally be attached to the device according to the invention.

Preferably, the second pivot joint comprises a receptacle formed at the free end of the support arm and two connecting elements positionable in the receptacle, of which a first connecting element is coupled to the survey marker in a rotationally fixed manner and a second connecting element can be actuated in frictional connection with the first element. To change the survey marker, the user can actuate the second connecting element in this embodiment, thereby releasing the frictional connection between the two connecting elements. The user then removes the survey marker from the support arm and replaces it with a new marker. To attach the new survey marker to the support arm, the user again actuates the second connecting element and thus re-establishes a frictional connection between the two connecting elements.

The first connecting element is, for example, a screw, while the second connecting element is a threaded bushing that can be rotated on the screw. The screw may be an injection-molded component integral with the survey marker. To attach the survey marker to a support arm, the user screws the internal thread of the threaded bushing onto the external thread of the screw. In doing so, the threaded bushing may be provided with an actuating element that facilitates the user screwing the threaded bushing onto the screw. For example, an externally accessible slot is provided on the threaded bushing into which the user inserts a screwdriver, coin or the like in order to use it to tighten the threaded bushing onto the external thread of the screw in a screwing motion.

In a particularly preferred embodiment, the first pivot joint includes a second detent mechanism that defines a plurality of rotational detent positions of the survey marker about the second axis. Like the first detent mechanism provided in the base, the second detent mechanism intended to rotate the survey marker may provide a plurality of discrete rotational detent positions at predetermined angular intervals. Assuming by way of example that the first detent mechanism defines n discrete detent positions and the second detent mechanism defines m discrete rotational detent positions, the interaction of the two detent mechanisms results in a total of n×m different orientations of the survey marker in space.

In an alternative embodiment, the device according to the invention can also be designed such that, instead of the detent mechanism described above, a stepless adjustment of the survey marker about the two axes is possible. In this case, the detent mechanisms can be dispensed with.

Preferably, the device comprises at least one adapter plate that can be inserted in a recess formed on the underside of the bottom plate and adapted in shape to the adapter plate. For example, the recess and, adapted thereto, the adapter plate each have the shape of a regular polygon with rounded corners. Such a shape makes it easier for the user to insert the adapter plate into the recess of the bottom plate in the correct position. The adapter can be used to attach the device according to the invention directly to the survey object or, for example, to a locating pin that is attached to the survey object.

The adapter plate has, for example, a through hole. In this case, the adapter plate is designed to be attached to a wooden pole, for example, by means of a screw passed through the through-hole.

In an alternative embodiment, the adapter plate has a threaded shank projecting from its plate body with an external thread and/or an internal thread. Via the threaded shank, the adapter plate can be screwed, for example, onto the external or internal thread provided on a surveying tripod in order to attach the device according to the invention to the surveying tripod. The threads are designed as ⅝″ threads, for example.

In another alternative embodiment, the adapter plate has a slip-on bushing projecting from its plate body. This slip-on bushing is used, for example, to place the adapter plate on a locating pin attached to the survey object. The shape of the slip-on bushing is preferably adapted to the locating pin such that a positive fit is produced between the slip-on bushing and the locating pin when it is placed thereon.

The adapter plate is preferably made of metal, for example stainless steel. This makes it possible to attach the adapter plate in the recess of the bottom plate by means of one or more magnets.

In a particularly preferred embodiment, the bottom plate of the base has a magnet arrangement on its underside. This magnet arrangement is formed, for example, from several magnets that are arranged in several magnet receptacles provided for this purpose on the bottom plate.

Preferably, the magnet arrangement for attaching the bottom plate to the survey object comprises several first magnets arranged in an edge region on the underside of the bottom plate. This makes it possible to mount the base of the device according to the invention solely magnetically, i.e. without additional fastening means on a survey object, provided that the latter consists of a magnetic metal.

Alternatively or additionally, the magnet arrangement for attaching the adapter plate to the bottom plate may comprise a plurality of second magnets arranged in the recess formed on the underside of the bottom plate. These second magnets may be used to attach an adapter plate made of a magnetic metal of the type described above to the recess formed in the bottom plate without additional fasteners.

Alternatively or additionally, the magnet arrangement may include a third magnet centered on the underside of the bottom plate. This allows the user to mount the base of the device to a locating pin without additional fasteners, provided the locating pin is made of a magnetic metal.

In another preferred embodiment, at least one non-slip nub is arranged on the underside of the bottom plate. This ensures that the base of the device attached to the survey object does not slip when the user twists the rotary plate of the base and/or the survey marker attached to the support arm. Preferably, a plurality of nubs are provided and arranged circumferentially in the edge region of the bottom plate.

The support arm preferably has the shape of an arc that approximately describes a quarter circle. The arc shape of the support arm allows the user to grip the survey marker from essentially all sides in order to rotate it about the second axis in the desired manner.

For example, the survey marker has the shape of a disk or a sphere, and it is preferably usable with a surveying instrument such as a laser, a scanner, and/or a total station. Although the afore-mentioned configurations are preferred embodiments, the survey marker is not limited in any way, particularly with respect to its shape. If a disk-shaped marker is used, the latter may have a circular shape, or it may have any other shape. Furthermore, the survey marker may be printed on one side only or on both sides.

According to a further aspect of the invention, there is provided a marking apparatus comprising a device of the type described above for marking the survey object and a surveying tripod and/or a prism pole, the device being attachable with its bottom plate to the surveying tripod and/or the prism pole.

Such a marking apparatus can be adapted to all common measuring systems in a particularly flexible manner. In particular, it is possible to always arrange the survey marker at the same distance from a reference point, regardless of the use of different adapters. For example, the center of the survey marker can be positioned at an exactly defined distance above a measuring prism.

Exemplarily, a marking apparatus configuration according to the invention comprises a tripod or tribrach on which a first adapter is mounted. Mounted on this first adapter is a measuring prism, on the top of which is mounted a second adapter. On the second adapter, the above-described device is mounted via its base, followed by the support arm with the survey marker attached to it. The base can be mounted, for example, by means of an adapter plate of the type described above, which has a threaded shank with an external thread projecting from its plate body.

The configuration given above is to be understood as an example only. As already indicated above, configurations are also possible in which the base of the device according to the invention is mounted, for example via magnetic interaction, directly on a survey object or on a locating pin which is itself magnetic.

The invention is explained in more detail below with reference to the figures in which:

### BRIEF DESCRIPTION OF THE DRAWINGS

FIG. 1 is a side view of a device for marking a survey object according to an embodiment;

FIG. 2 is a top view of the marking device;

FIG. 3 is a front view of the marking device;

FIG. 4 is another front view of the marking device with the survey marker rotated;

FIG. 5 is a side sectional view of the marking device;

FIG. 6 is a partial cutaway perspective view of the marking device to illustrate the construction of a base;

FIG. 7 is a partially cutaway perspective view of the marking device to illustrate a pivot joint arranged on a support arm;

FIG. 8 is another partially cutaway perspective view of the marking device to illustrate the pivot joint located in a support arm;

FIG. 9 is a rear view of the marking device;

FIG. 10 is a partially cutaway rear view of the marking device without the bottom plate to illustrate a detent mechanism integrated into the pivot joint;

FIG. 11 is a bottom view of the marking device illustrating the underside of a bottom plate of the base; and

FIG. 12 perspective views of different adapter plates.

### DETAILED DESCRIPTION

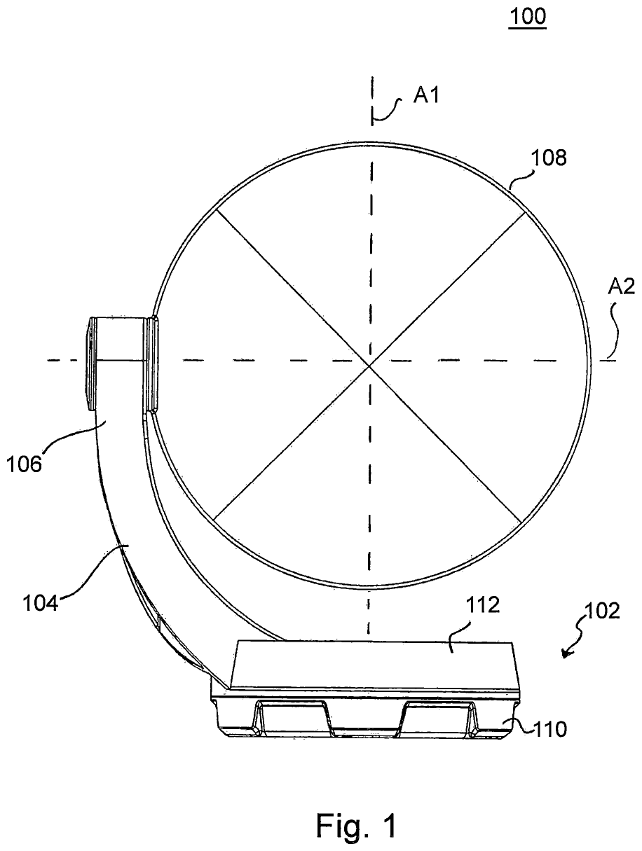

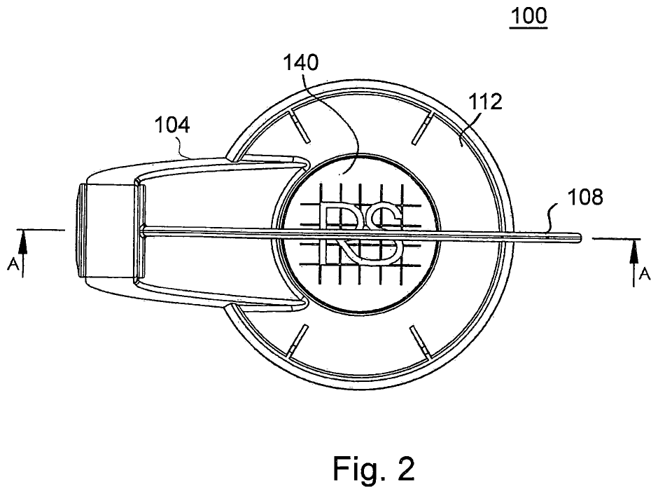

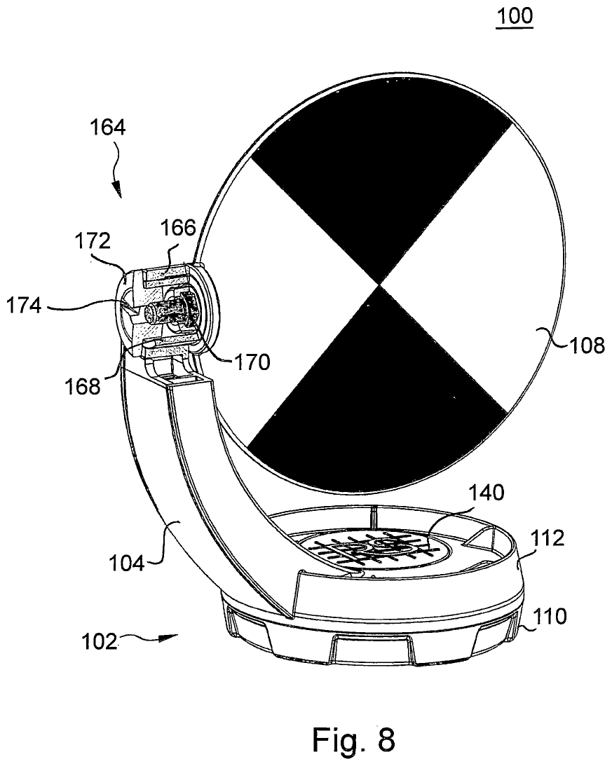

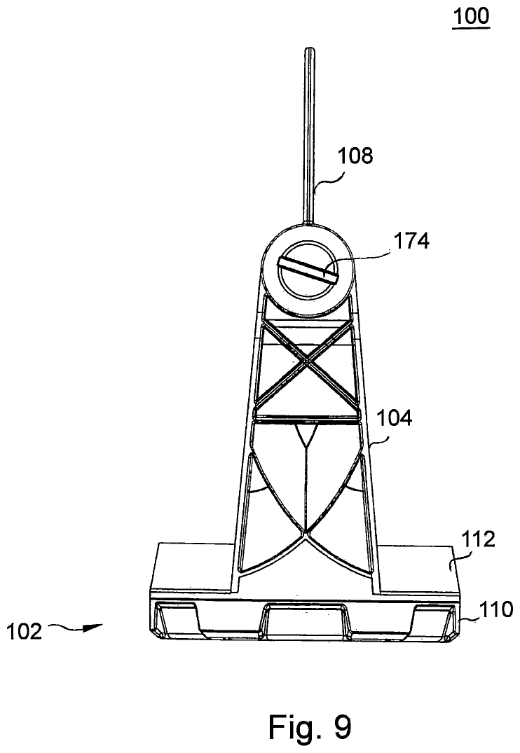

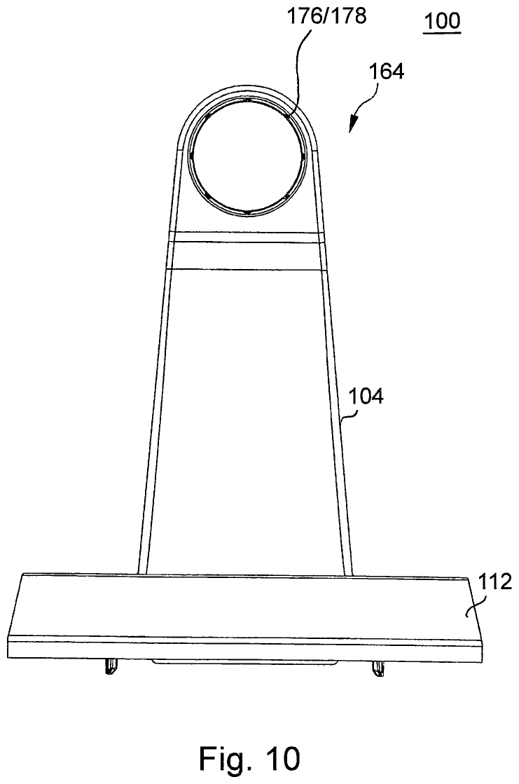

In the following, a specific embodiment of a device 100 according to the invention is described, which is used to mark a survey object that is not shown. The device 100 is used in a manner known per se together with a measuring device, for example a laser, a scanner, or a total station. In the following description, reference is made collectively to FIGS. 1 to 12, which show the device 100 in various views.

The device 100 includes a base 102 that is adapted to be attached to the survey object directly or with the aid of other accessories, such as suitable adapters (not shown in the figures). Extending from the base 102 is a support arm 104. In the present embodiment, the support arm 104 is in the form of an arc that approximately describes a quarter circle in the side view shown in FIG. 1. A survey marker 108 is attached to a free end 106 of the support arm 104. As explained in detail later, the device 100 is configured to allow the survey marker 108 attached to the support arm 104 to rotate about two axes A1 and A2 that are perpendicular to each other. As shown in FIG. 1, the two axes A1, A2 intersect at a center point of the survey marker 108. This means that the center point of the survey marker 108 remains stationary when the survey marker 108 is rotated about the two axes A1, A2.

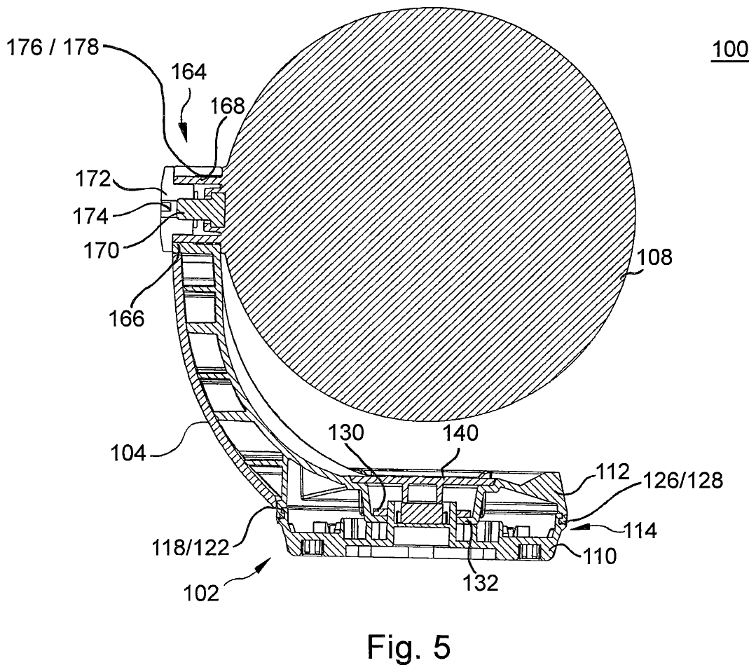

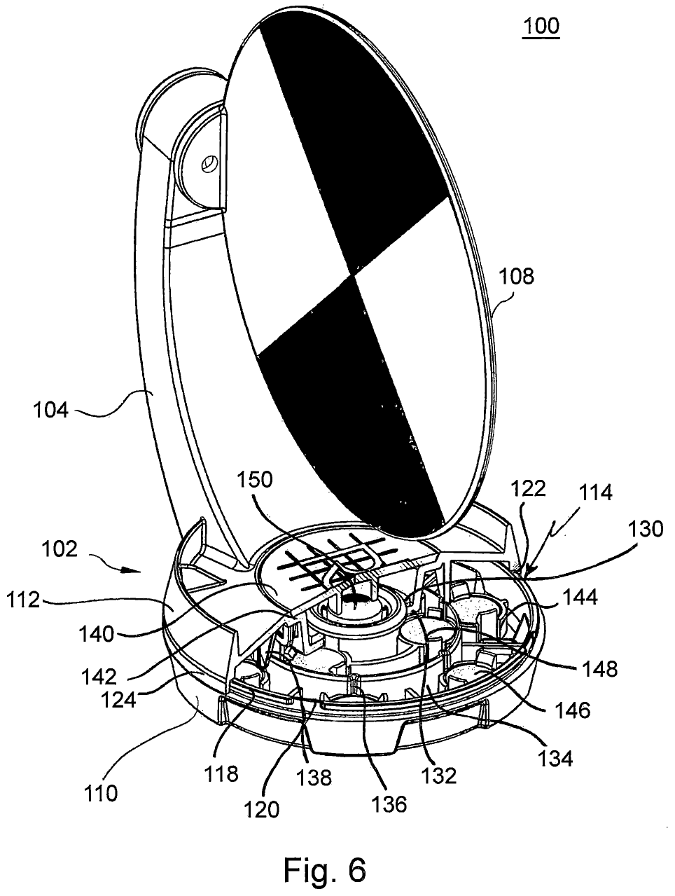

The base 102 of the device 100 is composed of a bottom plate 110 and a rotary plate 112 mounted thereon. As can be seen, for example, from FIGS. 5 and 6, the two plates 110, 112 in the present embodiment are formed from shell-like elements with their shell openings facing each other.

The bottom plate 110 is used to attach the device 110 to the survey object. Thus, the bottom plate 110 is stationary relative to the survey object. In contrast, the rotary plate 112 is coupled to the bottom plate 110 such that it can be rotated relative to the bottom plate 110 about the axis A1. For this purpose, the base 102 has a first pivot joint, generally designated by the reference sign 114 in FIG. 6.

As shown in FIGS. 5 and 6, the pivot joint 114 includes a circumferential protrusion 118 formed on an upwardly directed edge region 120 of the bottom plate 110. The pivot joint 114 further includes a groove 122 corresponding to the protrusion 118, which is provided in a downwardly directed edge region 124 of the rotary plate 112. The protrusion 118 engages the groove 122 so that the latter is guided along the protrusion 118 when the rotary plate 112 is rotated about the axis A1 relative to the bottom plate 110. A rotary guide corresponding to the pair 118/122 is formed by a further projection 126 and a further groove 128, the projection 126 being located on the rotary plate 112 and the groove 128 being located on the bottom plate 110. The two pairs of guides 118/122 and 126/128 form an encompassing rotary guide in the manner of an undercut. This rotary guide allows the user to rotate the rotary plate 112 relative to the bottom plate 110 about the axis A1.

As shown in FIGS. 5 and 6, the rotary plate 112 includes an annular sliding disk 130 that rests on a circumferential flange surface 132 formed on the bottom plate 110. The sliding disk 130 slides on the flange surface 132 as the rotary plate 112 rotates about the axis A1. Thus, the sliding disk 130 and the flange surface 132 are also part of the pivot joint 114.

Within the shell opening of the bottom plate 120 is a perimeter wall 134 having a plurality of vertically oriented detent notches 136 on its outer surface. The detent notches 136 correspond to a corresponding number of detent lugs 138 formed on the underside of the rotary plate 112 and directed vertically downward. When the rotary plate 112 is rotated about the axis A1, the detent lugs 138 slide along the outer surface of the wall 134 and engage the detent notches 136 in a corresponding rotational position. Thus, the detent notches 136 and the detent lugs 138 form a detent mechanism which at the same time helps to ensure that the rotary plate 112 is guided in its rotational movement in a stable and smooth manner.

The base 102 further comprises a lid 140 that is inserted from above into a corresponding opening of the rotary plate 112. Thereby, an edge portion at the underside of the lid 140 comes into contact with an annular step 142 that defines the afore-mentioned opening of the rotary plate 112.

The bottom plate 110 further has a plurality of magnet receptacles in its shell opening, one receptacle of which is designated with 144 in FIG. 6 as a representative example. Magnets are inserted in the receptacles 144, which are in different radial positions with respect to the axis of rotation A1. In the present embodiment, a plurality of first magnets 146 are provided and are positioned circumferentially in an edge region on the underside of the bottom plate 110. Radially within the first magnets 146 are a plurality of second magnets 148. Finally, a single magnet 150 is centrally positioned within the bottom plate 110. The bottom plate 110 is configured in coordination with the magnets 146, 148, 150 such that the latter are magnetically effective through the bottom plate 110.

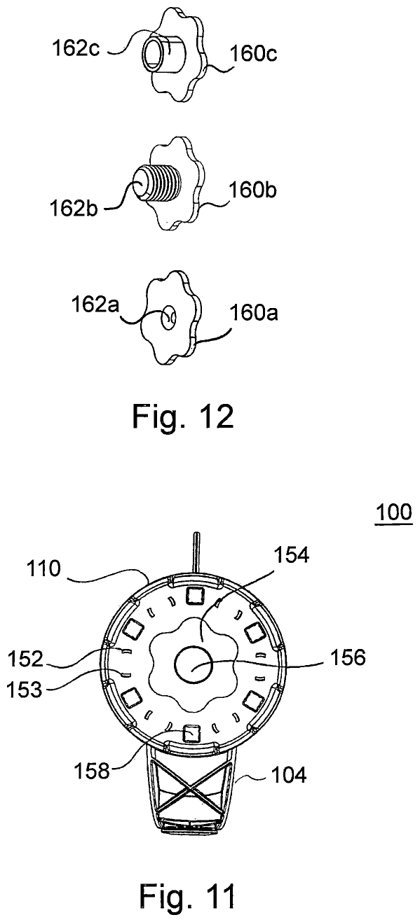

In the bottom view shown in FIG. 11, the first magnets 146 are each located between two recesses 152, 153 formed in the bottom plate 110. In contrast, the second magnets 148 are located in the region of a recess 154 provided on the underside of the bottom plate 102. In the embodiment shown, the recess 154 has the shape of a regular polygon with rounded corners. Finally, the third magnet 150 is located in the region of another central recess 156, which is also formed on the underside of the bottom plate 102. The central recess 156 is once again lowered by a certain amount relative to the surrounding recess 154 in the direction of the rotary plate 112.

There are also a plurality of non-slip nubs 158 on the underside of the bottom plate 110. These ensure that the base 102 attached to the survey object does not slip when the user manually rotates the rotary plate 112 or the survey marker 108 attached to the support arm 104.

An adapter plate can be inserted into the recess 154 provided on the underside of the bottom plate 110, which adapter plates are shown in Figure in different embodiments 160a, 160b, 160c. In the present embodiment, the respective adapter plate 160a, 160b, 160c is made of a magnetic metal, for example stainless steel. This makes it possible to fix the adapter plate 160a, 160b, 160c in the recess 154 solely by the action of the second magnets 148 without any further fastening means. To ensure a good hold in the recess 154, the adapter plate 160a, 160b, 160c has the shape of a rounded polygon in adaptation to the recess 154.

The adapter plate 160a has a central through hole 162a through which, for example, a screw can be passed to screw the adapter plate 160a to the survey object.

In an alternative embodiment, the adapter plate 160b has a threaded shank 162b that protrudes centrally from the plate body. The threaded shank 162b may be provided with an external thread, as shown in FIG. 12. Of course, it is also possible to provide the threaded shank with an internal thread. By means of the threaded shank 162b, the adapter plate 160b can, for example, be screwed onto an external or internal thread provided on a surveying tripod.

In another alternative embodiment, the adapter plate 160c has a central slip-on bushing 162c that protrudes centrally from the plate body. The slip-on bushing 162c can be used, for example, to slip the adapter plate 160 onto a locating pin that is attached to the survey object.

Each of the embodiments shown in FIG. 12 allows the user to first attach the adapter plate 160a, 160b, 160c to the survey object and then simply slip the base 102 onto the adapter plate 160a, 160b, 160c with the recess 154 formed on the bottom plate 110 thereof. By the action of the second magnets 144, the base 102 is securely held to the adapter plate 160a, 160b, 160c without the need for any other fasteners.

The device 100 further includes another pivot joint that allows the user to rotate the survey marker 108 about the axis A2. This pivot joint is generally designated by the reference sign 164 in FIGS. 5, 7, 8, and 10.

A circular cross-section receptacle 166 is located at the free end 106 of the support arm 104. A tubular socket 168 integrally formed with the survey marker 108 is inserted into the receptacle 166. Further, a screw 170 is an injection molded component integral with the survey marker 108 and disposed within the socket 168. The screw 170 is engaged with a threaded bushing 172, the internal threads of which are threaded onto the external threads of the screw 170. The screw 170 and the threaded bushing 172 form the connecting elements of a friction-locked exchange mechanism that allows the user to detach the survey marker 108 from the support arm 104 and replace it with a different marker, as needed. To facilitate changing the marker, the threaded bushing 172 has a slot 174 at its end remote from the receptacle 166 into which the user can insert a screwdriver, coin, or the like to tighten or loosen the threaded bushing 172 on or from the screw 170.

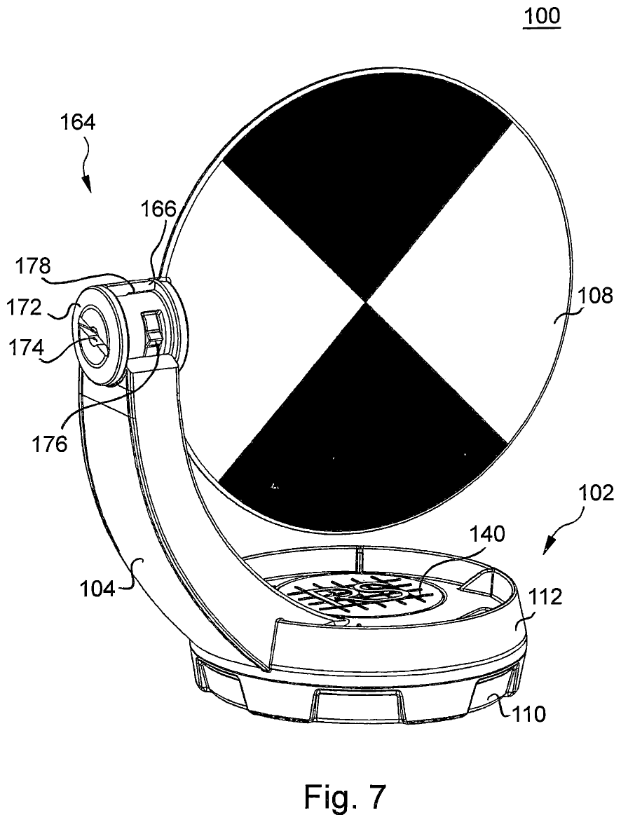

A plurality of detent lugs 176 are provided on the outer surface of the socket 168, corresponding to detent recesses 178 formed on the inner surface of the receptacle 166 (see in particular FIG. 7). As the user rotates the survey marker 108 about the axis A1, the detent lugs 176 of the socket 168 engage the detent recesses of the receptacle 166. This provides a detent mechanism in the pivot joint 164 that defines a plurality of rotational positions of the survey marker 108 about the axis A2.

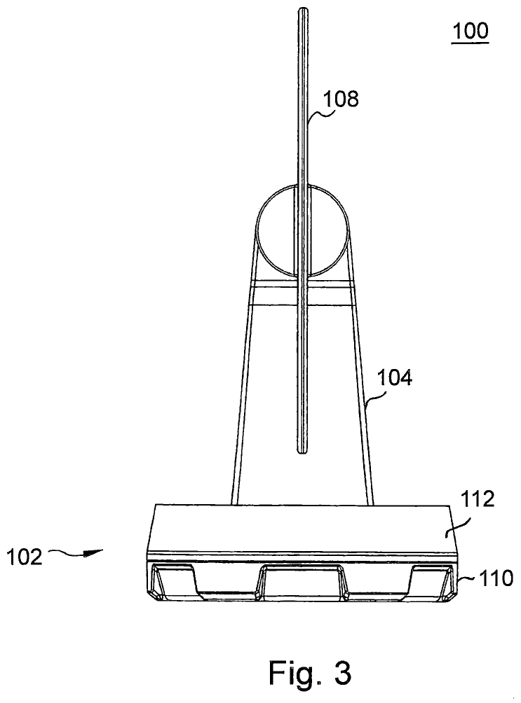

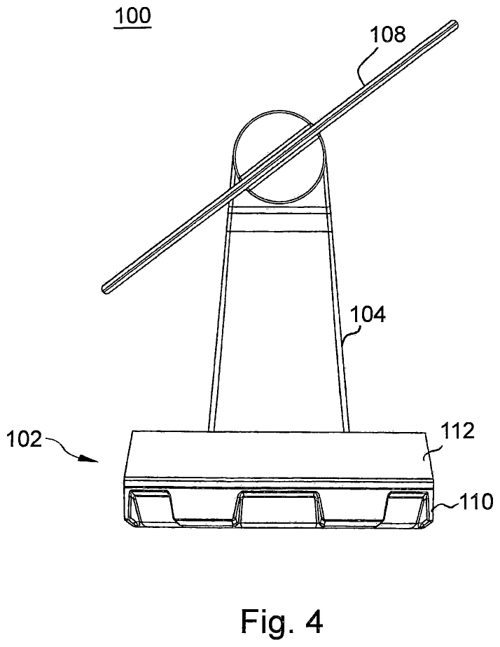

By means of the two pivot joints 114, 164 described above, the survey marker 108, which is detachably attached to the support arm 104, can be brought into a desired orientation relative to the bottom plate 110, which is non-rotatably attached to the survey object, by rotating it about the axes A1 and A2 as desired. FIGS. 3 and 4 show examples of two possible rotational positions of the survey marker 108 about the axis A2.

Since both pivot joints 114, 164 have detents, the orientation of the survey marker 108 in the present embodiment takes place in steps. However, it is equally possible to provide a stepless rotation of the survey marker 108. In this case, the detent mechanisms can be dispensed with.

What is claimed is:

1. A device for marking a survey object, comprising:
a base having a bottom plate attachable to the survey object, and a rotary plate disposed on the bottom plate and rotatable relative thereto about a first axis,
a single support arm projecting from and rotationally fixed relative to the rotary plate, and
a survey marker releasably attached to and rotatable relative to the free end of the support arm about a second axis that is perpendicular to the first axis.

2. The device according to claim 1, further comprising a first pivot joint disposed in the base and by which the rotary plate is rotatably connected to the bottom plate about the first axis.

3. The device according to claim 2, wherein the first pivot joint comprises at least one circumferential groove and at least one projection guided in the groove.

4. The device according to claim 2, wherein the first pivot joint comprises a first detent mechanism defining a plurality of rotational detent positions of the rotary plate about the first axis.

5. The device according to claim 2, further comprising a second pivot joint disposed at the free end of the support arm, by which the survey marker is rotatably connected to the support arm about the second axis of rotation.

6. The device according to claim 5, wherein the second pivot joint comprises an exchange mechanism that allows the survey marker to be detached from and attached to the support arm.

7. The device according to claim 5, wherein the second pivot joint comprises a receptacle formed on the free end of the support arm and two connecting elements positionable in the receptacle, a first connecting element of which is non-rotatably coupled to the survey marker and a second connecting element of which is actuatable in frictional connection with the first connecting element.

8. The device according to claim 7, wherein the first connecting element is a screw and the second connecting element is a threaded bushing rotatable on the screw.

9. The device according to claim 4, wherein the first pivot joint comprises a second detent mechanism defining a plurality of rotational detent positions of the survey marker about the second axis.

10. The device according to claim 1, further comprising at least one adapter plate insertable into a recess formed on the underside of the bottom plate and shaped to fit the adapter plate.

11. The device according to claim 10, wherein the adapter plate includes a through hole.

12. The device according to claim 10, wherein the adapter plate includes a threaded shank projecting from its plate body and having an external thread and/or an internal thread.

13. The device according to claim 10, wherein the adapter plate includes a slip-on bushing projecting from its plate body.

14. The device according to claim 10, wherein the adapter plate is made of metal, preferably stainless steel.

15. The device according to claim 1, wherein the bottom plate has a magnet arrangement on its underside.

16. The device according to claim 15, wherein the magnet arrangement comprises a plurality of first magnets disposed in an edge region on the underside of the bottom plate.

17. The device according to claim 16, wherein the magnet arrangement comprises a plurality of second magnets disposed in the recess formed on the underside of the bottom plate.

18. The device according to claim 17, wherein the magnet arrangement comprises a third magnet centered on the underside of the bottom plate.

19. The device according to claim 1, wherein at least one non-slip nub is disposed on the underside of the bottom plate.

20. The device according to claim 1, wherein the support arm has the shape of an arc that approximately describes a quarter circle.
